(19) United States
(12) Patent Application Publication
(10) Pub. No.: US 2011/0274677 A1
(43) Pub. Date: Nov. 10, 2011

(54) Biological Pest Control Mixture Containing D-Limonene and Nutmeg Oil

(76) Inventors: Bob Mullen, Ceylon (CA); Linda Louise Mullen, Ceylon (CA)

(21) Appl. No.: 12/991,559

(22) PCT Filed: Oct. 31, 2008
(86) PCT No.: PCT/CA08/01899

§ 371 Date: Mar. 11, 2011

(30) Foreign Application Priority Data
May 8, 2008 (CA) 2630960

(51) Int. Cl. A01N 43/30; A01P 7/04; A01P 3/00; A01P 1/00; A01N 37/18; A01N 35/02

(52) U.S. Cl. 424/94.1; 514/464; 514/701

(57) ABSTRACT

An organic pest control product comprising nutmeg oil and D-limonene is disclosed. In some embodiments the organic pest control product further comprises a miscibility enhancer to enhance the effectiveness of the product. In some embodiments the miscibility enhancer can comprise a liquid soap or detergent. Additional formulations that comprise cassia oil and/or eucalyptus oil are also disclosed. A method of use of an organic pest control product is also disclosed, in which the organic pest control product is effective to control a wide range of biological pests including fungi, bacteria, and insects, including those responsible for Dutch Elm Disease, fire blight, and Colony Collapse Disorder.

### FIELD OF THE INVENTION

The present invention relates to natural product mixtures effective for use in the control of insects, fungi, and other biological organisms, as well as methods for their use.

### BACKGROUND

One of the challenges faced by the agricultural industry is the susceptibility of plants and animals to biological agents in the form of pathogens and pests. Each year several million metric tons of compounds like pesticides and fungicides are applied to reduce the adverse effects of these biological agents, and thus to achieve an increase in agricultural yields and product quality. Generally pesticides and fungicides are synthetically produced chemicals, many of them derived from petrochemicals, which are non-renewable resources.

While the use of pesticides and fungicides is generally accepted as an effective way in which to control pathogens and increase agricultural outputs, there are disadvantages as well. For example, it is well known that excessive use of pesticides can have adverse effects on water quality, as well as on native plants, desirable insects, and, animals. In addition, some pesticides are toxic to humans, and so their use and misuse can lead to significant health consequences. These can include an increase in the incidence of cancer, damage to the immune system, and neurological problems, to name but a few.

For many plants, the application of pesticides also causes more immediate problems. For example, frequently pesticides burn foliage, roots, and flowers. In some cases flowering or fruiting is aborted. Additionally, plants frequently take several days to recover from the shock that toxic chemicals can cause, and in some cases plants never recover and subsequently perish. In other cases, pesticides can be taken up by plants, and may appear in products destined for human or animal consumption. In some cases, for example DDT, the persistence of a pesticide in the food chain can lead to serious detrimental effects.

### SUMMARY

It would be desirable to have an organic pest control product that is relatively safe for human use, and yet which is effective to control a broad spectrum of biologic pests. In particular it would be desirable to provide an organic pest control product that is effective, without being limiting, as an insecticide, an insect repellant, a fungicide, a bactericide, and an antiseptic.

It would be a further advantage to have an organic pest control product that is safe to use when applied directly to plants, animals, soil, or to structures.

It would also be an advantage to provide an organic pest control product that naturally degrades, and does not accumulate in the food chain.

Accordingly, the present disclosure provides a description of mixtures comprising novel organic pest control products, as well as methods for their use. These novel mixtures are found to be effective as insecticides, insect repellants, fungicides, bactericide, and antiseptics.

Mixtures of the present disclosure have also been found to be relatively non-irritating and safe for human use. In addition, the present organic pest control products minimize adverse side effects on plants to which they are applied, as compared to prior art petroleum-based pesticides.

Moreover, the mixtures of the present disclosure are naturally biodegradable and do not accumulate appreciably in the food chain.

Thus, in some embodiments, there is provided an organic pest control product comprising nutmeg oil, liquid soap, D-limonene, and a biostimulant. In some embodiments, the nutmeg oil, liquid soap, D-limonene, and biostimulant are provided in the form of a concentrate.

In some embodiments, the proportions of nutmeg oil, liquid soap, D-limonene are present in the concentrate in a ratio of about 1:4:2.

In some embodiments, the biostimulant can be added to the concentrate in an amount of about 1% to about 10%. In some embodiments, the biostimulant can be added in an amount from about 2% to about 8%. In some embodiments, the biostimulant can be added in an amount from about 4% to about 8%. In some embodiments, the biostimulant comprises at least one of Agri-Gro™, Agri-Gro™ Ultra, Agri-Gro™ Foliar, and combinations thereof.

In some embodiments, a working solution is prepared from the concentrate by mixing the concentrate with water. In some embodiments, the working solution comprises from about 1 mL to about 100 mL of concentrate per liter. In some embodiments, the working solution comprises from about 2 mL to about 10 mL of concentrate per liter. In some embodiments, the working solution comprises from about 2 mL to about 6 mL of concentrate per liter.

In some embodiments of a method of use of an organic pest control product, a working solution is applied at a rate of about 400 L per acre.

In some embodiments, a method of use comprises applying the concentrate to a solid matrix, and then placing the treated matrix in the area where pest control is desired. In some embodiments, a solid matrix comprises at least one of alfalfa pellets, wheat chop, sawdust, coconut fiber, and combinations thereof.

In some embodiments, a method of use comprises applying the pest control product to a plant. In some embodiments, a method of use comprises applying the pest control product to an animal. In some embodiments, a method of use comprises applying the pest control product to soil. In some embodiments, a method of use comprises applying the pest control product to a structure. In some embodiments, a method of use comprises selective eradication of pests, without affecting a desired species. In some embodiments the pest to be eradicated is the Varroa mite, and the desired species is a species of bee.

Thus, in some embodiments, there is provided an organic pest control product formulation, comprising nutmeg oil, D-limonene, and a miscibility enhancer, the formulation effective to control a biological pest, wherein the biological pest comprises at least one of fungi, bacteria, and insects. In some embodiments, the formulation comprises a concentrate. In some embodiments, the concentrate comprises from about 1% to about 50% nutmeg oil (v/v). In some embodiments, the concentrate comprises from about 5% to about 40% nutmeg oil (v/v). In some embodiments, the concentrate comprises from about 20% to about 30% nutmeg oil (v/v).

In some embodiments, the formulation comprising a working solution, the working solution comprising the concentrate diluted in a solvent. In some embodiments, the working solution comprises from about 0.1% to about 10% (v/v) concentrate. In some embodiments, the working solution comprises from about 0.2% to about 3% (v/v) concentrate. In some embodiments, the working solution comprises from about 0.2% to about 0.6% (v/v) concentrate.

In some embodiments, the organic pest control product further comprises a biostimulant, wherein the biostimulant comprises at least one of an enzyme, an amino acid, a plant growth hormone, a complex carbohydrate, and a macronutrient. In some embodiments, the biostimulant comprises from about 1% to about 20% of the concentrate (v/v). In some embodiments, the biostimulant comprises from about 2% to about 10% of the concentrate (v/v). In some embodiments, the biostimulant comprises from about 3% to about 5% of the concentrate (v/v).

In some embodiments, the nutmeg oil and miscibility enhancer are present in a ratio ranging from about 1:1 to about 1:10 (v/v). In some embodiments, the nutmeg oil and miscibility enhancer are present in a ratio ranging from about 1:1.5 to about 1:4 (v/v). In some embodiments, the nutmeg oil, D-limonene, and miscibility enhancer are presenting a ratio of about 1:2:4 respectively (v/v/v).

In some embodiments, the miscibility enhancer comprises at least one of a detergent and a surfactant. In some embodiments, the detergent comprises at least one of an anionic detergent, and a non-ionic detergent. In some embodiments, the detergent comprises at least one of sodium dodecyl sulfate and sodium lauryl sulfate. In some embodiments, the detergent comprises about 18% to about 24% solids (w/v).

In some embodiments of an organic pest control product, the biological pest is at least one of thrips, shore flies, tent caterpillars, canker works, broad mites, tomato fruit worm moths, roundworms, fungus gnats, box elder beetles, plant scale, gray spider mites, red spider mites, mealy bugs, white flies, grasshoppers, flea beetles, centipedes, black wooly aphids, peach aphids, white wooly aphids, elm tree aphids, army worms, cutworms, sow bugs, spiders, ants, worm moth, Varroa mites, cabbage loopers, and insect larvae. In some embodiments, the biological pest is at least one of a damping-off fungus, a root disease fungus, botrytis, powdery mildew, blue mold, gray mold, and Ophiostoma spp. In some embodiments, the biological pest is Erwinia amylovora.

In some embodiments, the organic pest control product further comprises a solid matrix material. In some embodiments, the matrix material comprises at least one of alfalfa pellets, sawdust, grain chop, and coconut fiber.

In some embodiments, an organic pest control product formulation comprises cassia oil, eucalyptus oil, and a miscibility enhancer, the formulation effective to control a biological pest. In some embodiments, the formulation further comprises a biostimulant, wherein the biostimulant comprises at least one of an enzyme, an amino acid, a plant growth hormone, a complex carbohydrate, and a macronutrient.

In some embodiments, an organic pest control product formulation comprises cassia oil, D-limonene, and a miscibility enhancer, the formulation effective to control a biological pest, wherein the biological pest comprises at least one of fungi, bacteria, and insects. In some embodiments, the formulation further comprises a biostimulant, wherein the biostimulant comprises at least one of an enzyme, an amino acid, a plant growth hormone, a complex carbohydrate, and a macronutrient.

In some embodiments, an organic pest control product formulation comprises cassia oil, eucalyptus oil, D-limonene, and a miscibility enhancer, the formulation effective to control a biological pest, wherein the biological pest comprises at least one of fungi, bacteria, and insects. In some embodiments, the formulation comprises further comprising a biostimulant, wherein the biostimulant comprises at least one of an enzyme, an amino acid, a plant growth hormone, a complex carbohydrate, and a macronutrient.

There is provide in some embodiments, a method of use of an organic pest control product, the method comprising applying a formulation comprising nutmeg oil, D-limonene, and a miscibility enhancer, in an amount effective to control a biological pest, wherein the biological pest comprises at least one of a fungi, bacteria, and insects.

In some embodiments of the method, the formulation is provided in the form of a concentrate. In some embodiments of the method, the concentrate comprises from about 1% to about 50% nutmeg oil (v/v). In some embodiments of the method, the concentrate comprises from about 5% to about 40% nutmeg oil (v/v). In some embodiments of the method, the concentrate comprises from about 20% to about 30% nutmeg oil (v/v).

In some embodiments of the method, the nutmeg oil and miscibility enhancer are present in a ratio ranging from about 1:1 to about 1:10 (v/v). In some embodiments of the method, the nutmeg oil and miscibility enhancer are present in a ratio ranging from about 1:1.5 to about 1:4 (v/v). In some embodiments of the method, the nutmeg oil, D-limonene, and miscibility enhancer are present in a ratio of about 1:2:4 respectively (v/v/v).

In some embodiments, the method further comprises preparing a working solution from the concentrate. In some embodiments of the method, the working solution comprises about 0.1% to about 10% concentrate (v/v). In some embodiments of the method, the working solution comprises about 0.2% to about 3% concentrate (v/v). In some embodiments of the method, the working solution comprises from about 0.2% to about 0.6% concentrate (v/v).

In some embodiments of the method, the working solution further comprises a biostimulant, effective to enhance the effectiveness of the organic pest control product. In some embodiments of the method, the biostimulant comprises at least one of an enzyme, an amino acid, a plant growth hormone, a complex carbohydrate, and a macronutrient. In some embodiments of the method, the biostimulant comprises from about 1% to about 20% of the concentrate (v/v). In some embodiments of the method, the biostimulant comprises from about 2% to about 10% of the concentrate (v/v). In some embodiments of the method, the biostimulant comprises from about 3% to about 5% of the concentrate (v/v). In some embodiments of the method, the biostimulant is added to a concentrate prior to preparing the working solution. In some embodiments of the method, the biostimulant is added to the working solution.

In some embodiments of the method, the fungus is at least one a damping-off fungus, botrytis, powdery mildew, blue mold, gray mold, and Ophiostoma spp. In some embodiments of the method, the fungus is Ophiostoma spp., and applying the formulation is effective to treat Dutch Elm Disease.

In some embodiments of the method, the bacterium is Erwinia amylovora, and the formulation is effective to treat fire blight.

In some embodiments of the method, the insect is at least one of thrips, shore flies, tent caterpillars, canker works, broad mites, tomato fruit worm moths, roundworms, fungus gnats, box elder beetles, plant scale, gray spider mites, red spider mites, mealy bugs, white flies, grasshoppers, flea beetles, centipedes, black wooly aphids, peach aphids, white wooly aphids, elm tree aphids, army worms, cutworms, sow bugs, spiders, ants, worm moth, Varroa mites, cabbage loopers, and insect larvae. In some embodiments of the method, the insect is the Varroa parasite, and applying the formulation in an amount effective to treat Colony Collapse Disorder. In some embodiments of the method, the effective amount is not toxic to bees.

In some embodiments of the method, the formulation is applied systemically. In some embodiments of the method, the formulation is applied topically. In some embodiments of the method, the formulation is applied to a growth substrate. In some embodiments of the method, the growth substrate is one of soil and a hydroponic growth substrate.

In some embodiments, the method further comprises admixing the formulation with a matrix material. In some embodiments of the method, the matrix material comprises at least one of alfalfa pellets, sawdust, grain chop, and coconut fiber.

In some embodiments the method comprises applying a formulation comprising cassia oil, eucalyptus oil, and a miscibility enhancer, the formulation effective to control a biological pest, wherein the biological pest comprises at least one of fungi, bacteria, and insects. In some embodiments of the method, the formulation further comprises a biostimulant, wherein the biostimulant comprises at least one of an enzyme, an amino acid, a plant growth hormone, a complex carbohydrate, and a macronutrient.

In some embodiments the method comprises applying a formulation comprising cassia oil, D-limonene, and a miscibility enhancer, the formulation effective to control a biological pest, wherein the biological pest comprises at least one of fungi, bacteria, and insects. In some embodiments of the method, the formulation further comprises a biostimulant, wherein the biostimulant comprises at least one of an enzyme, an amino acid, a plant growth hormone, a complex carbohydrate, and a macronutrient.

In some embodiments, the method comprises applying a formulation comprising cassia oil, eucalyptus oil, D-limonene, and a miscibility enhancer, the formulation effective to control a biological pest, wherein the biological pest comprises at least one of fungi, bacteria, and insects. In some embodiments of the method, the formulation further comprises a biostimulant, wherein the biostimulant comprises at least one of an enzyme, an amino acid, a plant growth hormone, a complex carbohydrate, and a macronutrient.

In some embodiments, the method comprises applying a formulation comprising applying a formulation comprising nutmeg oil, D-limonene, and a miscibility enhancer, in an amount effective to control a biological pest, wherein the biological pest comprises at least one of a fungi, bacteria, and insects. In some embodiments of the method, the formulation further comprises a biostimulant, wherein the biostimulant comprises at least one of an enzyme, an amino acid, a plant growth hormone, a complex carbohydrate, and a macronutrient.

### DETAILED DESCRIPTION

### Example Formulations

A variety of chemical compounds have been used to treat plants and animals in order to eliminate or at least inhibit the propagation of undesirable organisms such as insects, larvae, bacteria, fungi, and the like. As many of these pest can also be pathogenic, there is an advantage to be gained in their elimination in terms of plant and animal health, which can result in increased productivity, for example in commercial agricultural operations.

However, many of the pesticides, herbicides, or other like compounds used for treating agricultural products are toxic. As a result many require specialized shipping and handling as well as training of operators in their “safe” use. Accidental release of these compounds poses significant health and environmental concerns. In addition, many compounds break down slowly in the environment, with the result that toxins can accumulate over time. When this occurs in the food chain, the consequences to plant and animal health, and in particular human health can be significant.

The present disclosure describes embodiments of novel formulations for organic pest control products. The term pest is used in its broadest sense, and can include, without limitation, any undesirable bacteria, insect, larvae, fungus, or other biological organism whose presence can be deleterious to plants or animals.

In general, the formulations as described herein comprise nutmeg oil, D-limonene, a liquid soap/detergent, as well as a biostimulant. The formulations described provide several advantages including ease and safety of use as well as minimal impact on the environment.

Nutmeg oil is a volatile oil comprising borneol, eugenol, and myristicin, in addition to other components. In some methods, the constituents of nutmeg can be isolated by steam extraction of ground nutmeg yielding nutmeg oil. This crude nutmeg oil is widely used in the pharmaceutical, cosmetic, and food products industries. In the present disclosure, it has been discovered that nutmeg oil has significant pest control properties that can be further enhanced.

Therefore, in some embodiments, an organic pest control product comprises a mixture of nutmeg oil and liquid soap, diluted in water to make a working solution. The type of liquid soap is not necessarily limiting. In some embodiments, common dishwashing soaps are known to be useful. In some embodiments, the liquid soap comprises at least 18% solids content. In some embodiments, the liquid soap comprises at least 24% solids content.

Those of skill in the art will appreciate that various types of liquid soap may be used successfully in producing biologically active formulations as described herein. The soap is expected to function as a surfactant or detergent, in order to improve the miscibility of the nutmeg oil, other essential oils, or limonene, in the aqueous working solutions—i.e., as a miscibility enhancer. In some embodiments, purified detergents such as sodium dodecyl sulfate, sodium lauryl sulfate, and the like can also be used successfully. A liquid soap can also comprise ethanol. It is expected that anionic detergents, non-ionic detergents, as well as various surfactants well known in the art will also be useful in formulations like those presently disclosed. Thus, the choice of detergent, surfactant, or any other component that will aid in the miscibility of the various components in the formulation is not considered to be limiting to the scope of the invention.

The nutmeg oil, liquid soap, and any other components can first be mixed together to produce a “concentrate.” As used herein, the term “concentrate” refers to any composition containing nutmeg oil either alone, or in combination with other components, prior to dilution with water to produce the working solution. As used herein, the term “working solution” refers to an amount of concentrate diluted in water that is then used directly for treatment of pests that may be on, in, or near plants, animals, soil, and/or structures.

In some embodiments, the concentrate comprises nutmeg oil and liquid soap. The ratio of nutmeg oil to liquid soap can range from about 1:1 to about 1:10. In some examples, the ratio of nutmeg oil to liquid soap is about 1:4. In some examples, the ratio of nutmeg oil to liquid soap is about 1:1.5. Thus, in embodiments of the nutmeg oil concentrate, nutmeg oil can comprise from about 1% to about 50% of the concentrate. In some embodiments nutmeg oil can comprise from about 5% to about 40%. In some embodiments, nutmeg oil can comprise from about 20% to about 30% of the concentrate.

In some embodiments, a working solution made from a concentrate comprising nutmeg oil and liquid soap, comprises from about 12 mL to about 36 mL of concentrate per liter. Working solutions prepared in this way have been found to be moderately effective as insecticides, fungicides, larvicides, and antiseptics. The amount of working solution will depend of course on the desired application and amount of treatment required. In addition, descriptions of solutions on a “per liter” basis are for convenience of understanding the inventions. Working solution volumes can be scaled up or down as desired.

In some embodiments, the concentrate can further comprise a biostimulant mixture. In some embodiments, the biostimulant mixture comprised Agri-Gro™, Agri-Gro™ Ultra, or Agri-Gro™ Foliar biostimulant. Agri-Gro™ products are natural biostimulants in liquid concentrate form. These biostimulants comprise a mixture of enzymes, amino acids, plant growth hormones, complex carbohydrates, and macronutrients. Surprisingly, the addition of a biostimulant mixture to the concentrate results in a working solution that enhances the effectiveness of nutmeg oil, as compared to working solutions comprising nutmeg oil but without the biostimulant. In an exemplary concentrate solution comprising 8% Agri-Gro™, similar or greater effectiveness of the nutmeg oil in pest control was achieved using only about 8 to about 25 mL of the concentrate per liter of working solution, as compared to about 12 to about 36 mL of concentrate when no biostimulant was used. Thus, the biostimulant, which is not known to possess insecticidal activity, acts synergistically to increase the effectiveness of the nutmeg oil from about 2-fold to about 4-fold. In some embodiments, a biostimulant mixture comprising from about 1% to about 20% of the concentrate volume, is added to the concentrate. In some embodiments, the volume of added biostimulant mixture comprises about 2% to about 8% of the concentrate volume. In some embodiments, the volume of biostimulant mixture added to the concentrate comprises from about 3% to about 5% of the concentrate volume. Thus, to 100 mL of concentrate, biostimulant can be added in amounts ranging from about 1-20 mL, about 2-10 mL, or from about 3-5 mL.

In some embodiments, the biostimulant is added to the concentrate prior to preparation of the working solution. In some embodiments, the biostimulant is added to the working solution. In some embodiments, the biostimulant can be added to the concentrate, and then additional biostimulant can be added to the prepared working solution.

Without being held to one particular hypothesis or theory as to the mode of action of the mixture, it is expected that the biostimulant mixture may provide protective properties to plants treated with the mixture, while also enhancing the efficacy of the nutmeg oil in killing insects, larvae, and/or other pests, for example bacteria or fungi. In some aspects, the biostimulant mixture may improve the bioavailability of the nutmeg oil, or active ingredients thereof, such that penetration or uptake of the active components into the insect, larval, fungal or bacterial pest is enhanced. The biostimulant mixture may also be effective to increase the half-life of the active constituents of the nutmeg oil, for example the borneol, eugenol, or myristicin, such that they are present at biologically effective concentrations for extended periods of time. The use of a biostimulant such as Agri-Gro™ thus provides a significant advantage in enhancing the effectiveness of the nutmeg oil pest control formulation.

As described above, embodiments of working solutions made from concentrates comprising nutmeg oil and liquid soap were moderately effective in killing insect pests, and the efficacy of these formulations could be modestly improved by including a biostimulant mixture in the working solution. In some embodiments, D-limonene was included in the concentrate (D-limonene is the (R) enantiomer of limonene; also known as (+)-limonene. D-limonene is a relatively stable terpene that can be derived from citrus fruit by distillation. It is used in the chemical industry as an additive to provide fragrance to various products, and it is also known to be effective as a solvent. In the present case, it was discovered that the addition of D-limonene to a nutmeg oil containing concentrate resulted in a working solution in which there was an unexpected, and synergistic, enhancement of the effectiveness of the pest control properties of the composition, well beyond that previously observed. Thus, in some embodiments of formulations of the present disclosure, D-limonene is included in the concentrate formulation to greatly improve the efficacy and potency of an organic pest control product.

While not desiring to be held to any one theory or mode of operation, it is expected that D-limonene cooperates synergistically with the other components of the pest control product formulation to improve penetration of components of the composition into the pest organism to which the formulation is applied. For example, D-limonene, which is known to be an effective organic solvent, may increase the permeability of the outer cuticle of insects, and perhaps the cell walls of fungi, improving the biocidal activity of the composition. Thus, the D-limonene and the other components of the formulation act synergistically to provide a greatly improved organic pest control product.

### Example 1

### Use as an Insecticide

As described above, embodiments of a concentrate comprise nutmeg oil, liquid soap, and D-limonene. In some embodiments, the nutmeg oil, liquid soap, and D-limonene are present in the concentrate in a ratio of about 1:4:2, respectively. It must be kept in mind that this is an exemplary mixture and as such is only one possible example of a useful concentrate mixture. Other ratios of these components can be successfully used to prepare a working solution that will be effective as an insecticide, insect repellant, fungicide, and/or antiseptic. Those of skill in the art will be able to readily determine by routine experimentation other ratios of these components that are sufficient to produce a concentrate which when diluted to produce a working solution retains the desired properties and effectiveness.

Including a biostimulant in a concentrate that also comprises nutmeg oil, liquid soap, and D-limonene further enhances the effectiveness of the pest control working solution prepared from such a concentrate. Thus, in some embodiments of a nutmeg oil containing concentrate, a biostimulant can be added to the concentrate in an amount ranging from about 1% to about 20% of the volume of concentrate (v/v). In some embodiments, the biostimulant is added in an amount from about 2% to about 10% of the concentrate volume (v/v). In some embodiments, the biostimulant is added in an amount of about 3% to about 5% of the concentrate volume (v/v).

As described above, it was unexpectedly discovered that the inclusion of D-limonene in the concentrate mixture further enhanced the pest control properties of a working solution made from a nutmeg oil containing concentrate. For example, when a working solution prepared using a concentrate that did not include D-limonene (A in Table 1; 12-18 mL of concentrate per liter; concentrate comprised 30% nutmeg oil; i.e., 4.5 mL of nutmeg oil per liter of working solution) was applied to samples of spider mites, killing of the pests was relatively slow, and the kill rate was about 80-90%. Treatment of mealy bugs required from about 12 to about 36 mL of this same concentrate per liter in a working solution in order to achieve similar kill rates.

Significantly, surviving insects were noted after treatment. Survivors are not desirable as it creates the possibility of mutation of an organism, which in turn potentially leads to the development of resistance, a common problem in the use of antibiotics and pesticides. Over time, the development of biological resistance can render the pesticide ineffective even at greatly increased concentrations.

Surprisingly, when a working solution prepared with a nutmeg oil containing concentrate comprising D-limonene (Concentrate B in Table 1; 2 mL of concentrate per liter of working solution; 0.28% nutmeg oil per liter of working solution) was applied to spider mites or white flies, the insects were killed essentially instantly. A working solution comprising 6 mL of Concentrate B per liter was also effective for use as an insecticide against mealy bugs. Thus, the results show that when a nutmeg oil containing concentrate includes D-limonene, it is possible to use up to about 15-fold less nutmeg oil in the final working solution, and yet achieve more rapid and more efficient killing of pests, as compared to a working solution prepared from a concentrate that does not include D-limonene. These results are summarized in Table 1. Of note, none of the individual components in the concentrate are known to have the observed effects when used alone, and it is only in the combinations described that the observed properties are achieved. Thus, it is clear that these components are acting synergistically to produce a potent organic pest control product.

Working solutions made from concentrates as described (e.g., Concentrate B in Table 1) are generally prepared by mixing a volume of the concentrate with water. In some embodiments, 1 L of a working solution comprises from about 1 mL to about 100 mL of concentrate (i.e., from about 0.1% to about 10%). In some embodiments, 1 L of working solution comprises from about 2 mL to about 30 mL of concentrate (about 0.2% to about 3%). In some embodiments, 1 L of working solution comprises about 2 mL to about 6 mL of concentrate per liter (about 0.2% to about 0.6%).

Those of skill in the art will be able through routine experimentation, be able to determine the desired working solution for the particular pest to be controlled. Further, as discussed above, the amounts of working solution to be prepared are readily scalable, and as such the 1 L is provided for only as a convenient example of dilution rates for concentrates, and is not to be construed as limiting in the amount of solution that can be prepared at any one time.

In use, working solutions can be applied at a variety of application rates. In some embodiments, a working solution is applied at a rate of about 400 L (about 100 U.S. gallons) per acre to be treated. Those of skill in the art will be able to readily determine an optimal application rate for a particular use by routine experimentation. Thus, a method of use of an organic pest control product as described herein comprises the use of the product as an insecticide.

### Example 2

### Use as a Paralytic

Furthermore, in addition to the lethality noted above, embodiments of the present organic pest control product have been shown to have other effects on insects and other common organisms. Treatment of grasshoppers with working solution prepared using Concentrate B (See Table 1) resulted in an apparent paralytic or anesthetic effect. Grasshoppers so treated tend to sit still, and stop their normal chewing action.

Army worms treated similarly also appeared to suffer from a paralytic or anesthetic effect. This effect is nearly immediate, although after a period of time the worm appears to recover and is subsequently able to resume movement. Thus, a method of use of an organic pest control product as described herein comprises the use of the product as an insect paralytic.

### Example 3

### Use as a Repellant

Working solutions prepared using a concentrate like Concentrate B (Table 1) have also been found to be effective repellants when used on a number of different insects, including, but not limited to cutworms, sow bugs, spiders, and ants. Treatments of cutworms causes the pest to curl, roll over, and move away from the site of application of the product at increased speed. Cutworms will also avoid any area pre-treated with the pest control product. Similarly, treatment of sow bugs causes the pest to leave the sprayed area. The product continues to be effective as a repellant against sow bugs for at least 2 to 4 weeks. The product is also effective against spiders and ants, both of which will leave a treated area. Thus, a method of use of an organic pest control product as described herein comprises the use of the product as a repellant.

Formulations as described herein are also effective when used in open fields. For example, a 0.25% working solution of Concentrate B applied at a rate of about 400 L per acre were effective to eradicate tomato fruit worm moth and white flies. Moreover, the product was effective as a repellent such that two weeks later neither of these pests had returned to the sprayed area. Significantly, an adjacent, unsprayed field, showed the obvious presence of both of these pests further underscoring the effective of the composition as a repellant.

### Example 4

### Use as a Selective Pesticide

It has also been observed that embodiments of the organic pest control product as disclosed have little or no effect on some other types of insects. For example, wasps, ladybugs, dragonflies, bees, and houseflies are apparently unaffected by treatment with the product at dilution rates as described above. Likewise, these insects can all be observed to enter a treated area soon after spraying with the product, so it appears not to be a repellant against at least these insects. As some of these insects (e.g., bees, ladybugs, dragonflies) are considered desirable, the selectivity of the pest control product provides an additional unexpected advantage.

For example, it was observed that working solutions of the product could be prepared that had no effect when applied to bees, but which were lethal to the Varroa mite (Varroa destructor), a problematic bee pest. The Varroa mite is a parasitic insect that attacks honeybees of the species Apis cerana, and Apis mellifera. This mite has also been associated with Colony Collapse Disorder, a disease currently spreading through North American bee populations, and which decimates bee colonies. Thus, formulations of the present disclosure may have significant utility in protecting commercially important bee populations.

Significantly, concentrations of product were found that were acceptable to the bees, permitting direct treatment of the hive. As pollination by bees is estimated to be essential for about ⅓ of the world's food productions, the impact of any treatment that can enhance bee survival is of significant economic importance. Thus, in some embodiments, a method of use of an organic pest control product as described herein comprises applying the working solution to a beehive in an amount effective to kill Varroa mites, but which is not harmful to the bees.

Embodiments of the pest control product were also found to be partially effective against cabbage loopers (Trichoplusia ni). Cabbage loopers feed on a variety of crops consuming foliage, and are one of the most destructive of insect pests of vegetables. It was observed that treatment with formulations as described result in some lethality within one hour of spraying, with increasing killing over the next 1-4 days. The product also appears to be partially effective as a repellent against this pest.

Table 2 summarizes some examples of the various biological effects of formulations of the organic pest control product of the present disclosure, and exemplary, non-limiting examples or pests that are affected by treatment with these formulations. Embodiments of the organic pest control product of the present disclosure have also been shown to be effective against a broad array of organisms. For example, in addition to insects, the present compositions have been discovered to have anti-fungal, as well as antiseptic properties.

### Example 5

### Use as a Larvicide

It has also been discovered that a nutmeg oil concentrate as described in Concentrate B is effective as a larvicide when applied to a solid matrix, for example, alfalfa pellets. In one example, Concentrate B was added to alfalfa pellets at a rate of 12 L per tonne of pellets. When applied to radish plants at a rate of about 400 kg (about 850 lbs) per acre, the treated alfalfa pellets were effective as a larvicide. The results of these experiments also suggested that the treated pellets were effective as a repellant. In some embodiments, a solid matrix can comprise, without limitation, alfalfa pellets, sawdust, grain chop, coconut fiber, and combinations thereof.

When examined for pest damage, only about 2% of the treated radish roots show signs of pest damage, as compared to more than 80% damaged plants in untreated control samples. In other tests, treatment of summer turnip or rutabaga with the pest control product was effective in protecting the plant from pest invasion. Thus, a method of use of an organic pest control product as described herein comprises the use of the product as a larvicide.

In some embodiments a working solution comprising from about 2 mL to about 6 mL of concentrate per liter was applied as a drench to a planted area, and was effective as a larvicide. Conveniently, the treatment can be applied to a variety of plantings, including potted plants, and plants either in a greenhouse and/or in an outdoor field. In addition, the organic pest control product is also useful in treating hydroponically grown plants.

### Example 6

### Use as a Fungicide

Formulations of the organic pest control product as described have been found to be effective in controlling damp-off, root disease, botrytis, and powdery mildew. For example, the product has been found to be effective in treating powdery mildew in peas, zinnia, roses, and lilac. The pest control product is also effective against gray mould on strawberries, as well as blue mold on citrus. Initial testing also indicates that the pest control product is effective in treating Gamoderma.

Based on these results, those of skill in the art will readily appreciate that the product will likely be generally useful as an anti-fungal agent compatible for use in a broad range of application where control of fungi such as mold and mildew is desired. It has also been found that the pest control product is effective to protect seeds from fungal infection. Thus, a method of use of an organic pest control product as described herein comprises the use of the product as a fungicide.

### Example 7

### Use as an Antiseptic

Similarly, formulations of the present disclosure have been found to be effective as an antiseptic. Cuttings of plants either sprayed or dipped in a 0.2% working solution were effectively protected from cutting losses due to fungal infection. In other tests, treatment with a similar formulation was 100% effective in preventing gall in cuttings. Thus, a method of use of an organic pest control product as described herein comprises the use of the product as an antiseptic.

### Example 8

### Use to Treat Dutch Elm Disease

Formulations of the present invention have been found to be effective in treating Dutch Elm Disease. Duth Elm Disease is a fungal disease of elm trees caused by Ophiostoma spp. Of Ascomycete microfungi, and is spread by bark beetles. Prior art methods of treatment include injection of infected trees with carbendazim phosphate, thiabendazole hypophosphite, or propiconazole, each of which require special handling due to the potential for toxic effects.

American Elm trees showing symptoms of Dutch Elm infection were treated. Involvement of the test trees with the disease ranged from 10-15% to about 60-70% prior to treatment. Each tree was treated by injection with a formulation prepared from a concentrate comprising nutmeg oil, liquid soap, and D-limonene in a ratio of about 1:4:2 parts, respectively. In addition, to the concentrate was added Agri-Gro Foliar™ at a rate of 5% (v/v).

In one case, treatment comprised injection of a working solution comprising concentrate mixed with water in ratios ranging from about 2:1 to about 3:1 (concentrate: water)(v/v). Treatment was applied at a rate ranging from about 12.5 mL to about 16.5 mL per centimeter of trunk diameter. Injection was performed using systemic tree injection tubes. In some cases trees accepted the entire injection volume, while in others the full volume was not accepted. In every case, at least 50% of the initial dosage volume was successfully injected into the affected tree.

Diseased trees that had been treated were re-examined at approximately one month and two month intervals. In all trees examined healthy green leaves were observed outside the original diseased area, and trees showed no obvious signs of Dutch Elm Disease infection.

### Example 9

### Use to Treat Fire Blight in Mountain Ash

Formulations of the present invention have also been tested for effectiveness in treating Fire Blight in Mountain Ash. Fire blight is caused by the bacterium Erwinia amylovora. Prior art treatment methods include treatment with streptomycin.

In one example, a mountain ash tree showing symptoms of fire blight, including approximately 10-15% tree death was treated using a solution prepared by mixing concentrate with water in about a 4:1 ratio. The working solution was applied by injection at an effective rate of about 17.5 mL per centimeter of trunk diameter. The effective rate is based on the actual amount of working solution that was successfully injected into the tree. About 10 days later, the tree was further sprayed with a working solution comprising 1% concentrate diluted in water (v/v). The tree was re-evaluated approximately two weeks later and showed no further spread of fire blight.

### Additional Formulations

In addition to the formulations described above other embodiments of an organic pest control product have been developed. In some embodiments, the organic pest control product comprises at least one of eucalyptus oil, cassia oil, ginger oil, camphor oil, rosemary oil, grapefruit oil, and combinations thereof. In some embodiments the formulation further comprises nutmeg oil. In some embodiments the formulation further comprises D-limonene.

An exemplary embodiment of a concentrate comprises cassia oil, eucalyptus oil, and about 5% Agri-Gro™ biostimulant. In one method of use, the concentrate is mixed with water at 3 mL per liter (i.e., a 0.3% working solution). This working solution has been found to be effective on aphids with a 100% kill rate after a single application. Killing occurs over a period of about 48 hours. This formulation has also been shown to be effective against both juvenile and adult centipedes, as well as spider mites and mealy bugs. The effect on mites and mealy bugs is instantaneous.

### Exemplary Formulas

The following concentrate formulations have also been produced and tested (measures are on a v/v basis).

BL1

1 part cassia oil

1 part eucalyptus oil

4 parts liquid soap (miscibility enhancer)

Biostimulant in an amount ranging from about 1-20% (v/v relative to concentrate)

BL4

1 part cassia oil

2 parts D-limonene

4 parts liquid soap (miscibility enhancer)

Biostimulant in an amount, ranging from about 1-20% (v/v relative to concentrate)

Controls flea beetles.

BL5

1 part cassia oil

1 part eucalyptus oil

2 parts D-limonene

6 parts liquid soap (miscibility enhancer)

Biostimulant in an amount ranging from about 1-20% (v/v relative to concentrate)

Each of the above formulations was tested at a working concentration of about 0.5% (v/v) diluted in water. The BL1 formula has been observed to be effective in controlling cabbage loopers, cabbage moths, flea beetles, centipedes, black wooly aphids, peach aphids, white wooly aphids and elm tree aphids. BL1 appears to be more effective than BL4 and BL5, with the exception that BL4 appears more effective in controlling flea beetles. BL1 is effective to kill cabbage loopers within seconds, and aphids within two days after spraying. A single drench with BL1 is effective to control centipedes for several days. BL4 is effective to kill flea beetles within minutes.

### Safety

Treatment of plants with typical working solutions appeared to have no adverse effects. Unlike other pesticides, which can be toxic to plants, the use of formulations of the present disclosure actually appears to improve the health of treated plants.

Working solutions up to 10% were applied to plants in “leaf burning” tests. At concentrations of 10% some burning of plants could be observed at the outer edges of leaves. Using a 5% working solution, no burning was observed. Typical working solutions can range from about 0.1% to about 0.6% depending on the pest being controlled, and thus well below the concentrations observed to result in leaf burning.

Together, embodiments of the pest control product as described above can be effectively used to treat plants, animals, soil, structures, and any other objects that may be reservoirs for pests such as larval, fungal, bacterial, and/or insect pests. Conveniently, the treatment can be applied to a variety of plantings, including potted plants, and plants either in a greenhouse and/or in an outdoor field. In addition, the organic pest control product is also useful in treating hydroponically grown plants

The foregoing is considered as illustrative only of the principles of the invention. Thus, while certain aspects and embodiments of the disclosure have been described, these have been presented by way of example only and are not intended to limit the scope of the disclosure. Indeed, the novel methods and systems described herein may be embodied in a variety of other forms without departing from the spirit thereof.

TABLE 1
Relative Effectiveness of Mixtures Against Spider Mites

| | | | | Example | | Additional |
|---|---|---|---|---|---|---|
| Concen- | Nutmeg | Liquid | D-limo- | Working | | Observa- |
| trate | Oil | Soap | nene | Solutions | % Kill | tions |
| A | 3 parts | 7 parts | — | 12-18 mL | 80-90% | Surviving |
| | | | | per liter | | insects |
| | | | | (1.2-1.8% | | observed |
| | | | | working | | after |
| | | | | solution; | | 24 hrs |
| | | | | Nutmeg | | |
| | | | | oil = 3.6 | | |
| | | | | to 5.4 | | |
| | | | | mL/L) | | |
| B | 1 part | 4 parts | 2 parts | 2 mL per | Virtually | Effective |
| | | | | liter (0.2% | 100% | instantly |
| | | | | working | | |
| | | | | solution) | | |
| | | | | (Nutmeg | | |
| | | | | oil = 0.28 | | |
| | | | | mL/L) | | |

Note:
Biostimulant is added to the concentrate at rate in the range of 1-20% (v/v). Biostimulant can be added to the concentrate, to the working solution, or to the concentrate and the working solution.

TABLE 2
Summary of Effects on Various Insect Pests

| Property | Effective Against |
|---|---|
| Lethal | Red spider mites, white flies, mealy bugs, cabbage loopers |
| | (partial effect), small roundworms, Varroa mite, fungus |
| | gnats, box elder beetles, plant scale, gray spider mites, |
| | thrips, shore fly, flea beetles, tent caterpillars, canker |
| | worms, broad mite, tomato fruit worm moth, black wooly |
| | aphid, peach aphids. |
| Repellant | Grasshoppers, cabbage loopers, cutworm, sow bugs. |
| and/or | |
| Paralytic | |
| No Effect | Bees, wasps, ladybugs, dragonflies, houseflies. |

1-70. (canceled)

71. An organic pest control product formulation comprising nutmeg oil, D-limonene, and a miscibility enhancer, the formulation being effective to control a biological pest, wherein the biological pest comprises at least one of fungi, bacteria, and insects.

72. The organic pest control product of claim 71, wherein the formulation comprises a concentrate.

73. The formulation of claim 72, wherein the concentrate comprises from about 1% to about 50% nutmeg oil (v/v).

74. The organic pest control product of claim 72, wherein the concentrate comprises from about 5% to about 40% nutmeg oil (v/v).

75. The organic pest control product of claim 72, wherein the concentrate comprises from about 20% to about 30% nutmeg oil (v/v).

76. The organic pest control product of claim 72, wherein the formulation comprises a working solution, the working solution comprising the concentrate diluted in a solvent.

77. The organic pest control product of claim 76, wherein the working solution comprises from about 0.1% to about 10% (v/v) concentrate.

78. The organic pest control product of claim 76, wherein the working solution comprises from about 0.2% to about 3% (v/v) concentrate.

79. The organic pest control product of claim 76, wherein the working solution comprises from about 0.2% to about 0.6% (v/v) concentrate.

80. The organic pest control product of claim 72, further comprising a biostimulant, wherein the biostimulant comprises at least one of an enzyme, an amino acid, a plant growth hormone, a complex carbohydrate, and a macronutrient.

81. The organic pest control product of claim 80, wherein the biostimulant comprises from about 1% to about 20% of a concentrate (v/v).

82. The organic pest control product of claim 80, wherein the biostimulant comprises from about 2% to about 10% of a concentrate (v/v).

83. The organic pest control product of claim 80, wherein the biostimulant comprises from about 3% to about 5% of a concentrate (v/v).

84. The organic pest control product of claim 71, wherein the nutmeg oil and the miscibility enhancer are present in a ratio of from about 1:1 to about 1:10 (v/v).

85. The organic pest control product of claim 71, wherein the nutmeg oil and the miscibility enhancer are present in a ratio of from about 1:1.5 to about 1:4 (v/v).

86. The organic pest control product of claim 71, wherein the nutmeg oil, D-limonene, and miscibility enhancer are present at a ratio of about 1:2:4 respectively (v/v/v).

87. The organic pest control product of claim 71, wherein the miscibility enhancer comprises at least one of a detergent and a surfactant.

88. The organic pest control product of claim 87, wherein the detergent comprises at least one of an anionic detergent, and a non-ionic detergent.

89. The organic pest control product of claim 87, wherein the detergent comprises at least one of sodium dodecyl sulfate and sodium lauryl sulfate.

90. The organic pest control product of claim 87, wherein the detergent comprises about 18% to about 24% solids (w/v).

91. The organic pest control product of claim 71, further comprising a solid matrix material.

92. The organic pest control product of claim 70, wherein the matrix material comprises at least one of alfalfa pellets, sawdust, grain chop, coconut fiber, legume material pellets, and legume material powder.

93. An organic pest control product formulation comprising cassia oil, eucalyptus oil, and a miscibility enhancer, the formulation being effective to control a biological pest, wherein the biological pest comprises at least one of fungi, bacteria, and insects.

94. The organic pest control product of claim 93, further comprising D-limonene.

95. The organic pest control product of claim 93, further comprising a biostimulant, wherein the biostimulant comprises at least one of an enzyme, an amino acid, a plant growth hormone, a complex carbohydrate, and a macronutrient.
